(19) United States
(12) Patent Application Publication
(10) Pub. No.: US 2025/0278793 A1
(43) Pub. Date: Sep. 4, 2025

(54) SYSTEM AND METHOD FOR COMPUTER BASED RISK CONTROL ANALYSIS

(71) Applicant: USI Insurance Services LLC, Valhalla, NY (US)

(72) Inventors: Mike Sicard, Mount Kisco, NY (US); Renee Dube, Otis, MA (US); Tanay Sheth, Brooklyn, NY (US); Sandy Troutman, Las Cruces, NM (US); Mitchell Hinkle, Oakley, CA (US)

(21) Appl. No.: 19/067,007

(22) Filed: Feb. 28, 2025

Related U.S. Application Data
(60) Provisional application No. 63/561,148, filed on Mar. 4, 2024.

(51) Int. Cl. G06Q 40/08; G06F 3/0483

(52) U.S. Cl. CPC G06Q 40/08; G06F 3/0483

(57) ABSTRACT

A method, computer program product, and computing system for receiving client attribute data, identifying one or more relevant coverage lines based on the received client attribute data, and generating a solution matrix for each of the one or more relevant coverage lines.

### CROSS-REFERENCE TO RELATED APPLICATIONS

This application claims the benefit of and priority to U.S. Provisional Patent Application No. 63/561,148 filed on Mar. 4, 2024, titled “PATH Process,” the entire contents of which are incorporated herein by reference.

### BACKGROUND

In the insurance industry, effective claims handling and risk management may be critical to maintaining financial stability, ensuring customer trust, and complying with regulatory requirements. Claims processing may be a core function that directly impacts an insurer's profitability and reputation, as timely and fair settlements may enhance customer satisfaction while preventing fraudulent claims. Risk management may play an equally vital role by enabling insurers to assess, mitigate, and price risks accurately, helping them maintain a sustainable business model. With the increasing complexity of insurance products and regulatory frameworks, insurers may seek to streamline claims processing and improve risk assessment. Moreover, proactive risk management strategies, may allow insurers to anticipate potential losses and reduce unnecessary payouts.

By integrating robust claims handling processes with advanced risk management techniques, insurance companies may enhance operational efficiency, minimize financial losses, and provide policyholders with more reliable protection.

### SUMMARY OF DISCLOSURE

In one example implementation, a computer-implemented method executed on a computing device may include but is not limited to, receiving client attribute data at a network server, identifying one or more relevant coverage lines based on the received client attribute data at the network server, and generating a solution matrix for each of the one or more relevant coverage lines at the network server, wherein the generated solution matrix is configured to be displayed on a graphical user interface (GUI).

One or more of the following example features may be included. Each solution matrix may include a set of possible solutions and each solution from the set of possible solutions may be represented as a point in the solution matrix. Each point in the solution matrix includes one or more loss drivers. In response to selecting a solution from the solution matrix, presenting a solution page for the selected solution on the GUI. The solution page may include more detailed information about the selected solution and one or more of a projection tool, a return on investment (ROI) analysis, an interactive calculator, and a vendor comparison. Identifying one or more vendors related to the selected solution at the network server, generating a vendor score for each vendor based on a set of viability factors at the network server, and generating a comparison table for the one or more vendors based on the generated vendor scores at the network server, where the generated comparison table may configured to be displayed on the GUI. The set of viability factors may include at least one of relevance of vendor products to the selected solution, history of performance, overall price, availability of discounts. In response to selecting a vendor from the comparison table, presenting a vendor page on the GUI. The vendor page includes one or more of an overview of vendor products and services, available discounts, and contact information.

In another example implementation, a computing system includes at least one processor and at least one memory architecture coupled with the at least one processor, where the at least one processor is configured to receive client attribute data at a network server, to identify one or more relevant coverage lines based on the received client attribute data at the network server, and to generate a solution matrix for each of the one or more relevant coverage lines at the network server, where the generated solution matrix may be configured to be displayed on a graphical user interface (GUI).

One or more of the following example features may be included. Each solution matrix may include a set of possible solutions, and each solution from the set of possible solutions is represented as a point in the solution matrix. Each point in the solution matrix includes one or more loss drivers. In response to selecting a solution from the solution matrix, presenting a solution page for the selected solution on the GUI. The solution page may include more detailed information about the selected solution and one or more of a projection tool, a return on investment (ROI) analysis, an interactive calculator, and a vendor comparison. The at least one processor may be further configured to identify one or more vendors related to the selected solution at the network server, generate a vendor score for each vendor based on a set of viability factors at the network server, and generate a comparison table for the one or more vendors based on the generated vendor scores at the network server, where the generated comparison table may be configured to be displayed on the GUI. The set of viability factors may include at least one of relevance of vendor products to the selected solution, history of performance, overall price, availability of discounts. In response to selecting a vendor from the comparison table, presenting a vendor page to be displayed on the GUI. The vendor page may include one or more of an overview of vendor products and services, available discounts, and contact information.

In another example implementation, a computer program product resides on a computer readable medium that has a plurality of instructions stored on it. When executed by a processor, the instructions cause the processor to perform operations that may include but are not limited to, receiving client attribute data at a network server, identifying one or more relevant coverage lines based on the received client attribute data at the network server, and generating a solution matrix for each of the one or more relevant coverage lines at the network server, where the generated solution matrix may be configured to be displayed on a graphical user interface (GUI).

One or more of the following example features may be included. Each solution matrix may include a set of possible solutions and each solution from the set of possible solutions may be represented as a point in the solution matrix.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a risk control and analysis process coupled to a distributed computing network according to one or more example implementations of the disclosure;

FIG. 2 is an example flowchart of the risk control and analysis process of FIG. 1 according to one or more example implementations of the disclosure;

FIG. 3 is an example of a dashboard page according to one or more example implementations of the disclosure;

FIG. 4 is an example of a solution matrix according to one or more example implementations of the disclosure;

FIG. 5 is an example of a solution page according to one or more example implementations of the disclosure;

FIG. 6 is an example of an ROI calculator according to one or more example implementations of the disclosure;

FIG. 7 is an example of a projection tool according to one or more example implementations of the disclosure;

FIG. 8 is an example of a vendor comparison according to one or more example implementations of the disclosure;

FIG. 9 is an example of a vendor page according to one or more example implementations of the disclosure; and

FIGS. 10-21 are example diagrammatic views of the risk control and analysis process of FIG. 1 according to one or more example implementations of the disclosure.

Like reference symbols in the various drawings indicate like elements.

### DETAILED DESCRIPTION

### System Overview

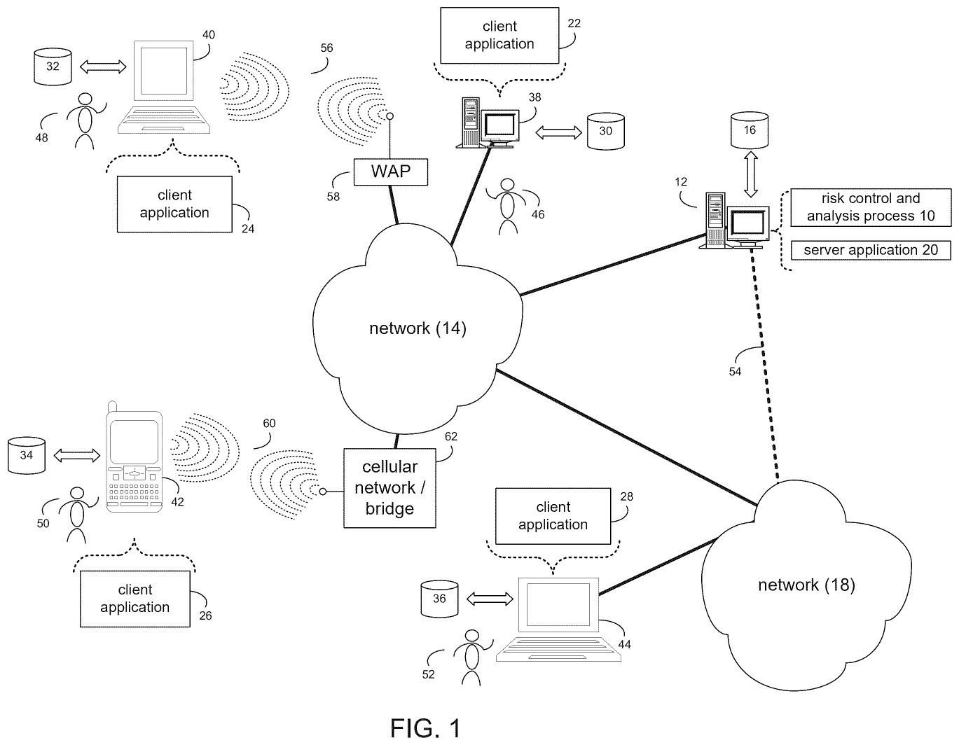

Referring to FIG. 1, there is shown risk control and analysis process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linuxt™, for example. Additionally and/or alternatively, the routing topology process may reside on a client electronic device, such as a personal computer, notebook computer, personal digital assistant, or the like.

The instruction sets and subroutines of the risk control and analysis process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute risk control and analysis process 10. Examples of client applications 22, 24, 26, 28 may include, but are not limited to, EDAs or design verification tools such as those available from the assignee of the present disclosure. These applications may also be executed by server computer 12. In some embodiments, risk control and analysis process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, risk control and analysis process 10 may be a client-side application residing on one or more client electronic devices 38, 40, 42, 44 (e.g., stored on storage devices 30, 32, 34, 36, respectively). As such, risk control and analysis process 10 may be a stand-alone application that interfaces with a client application (e.g., client applications 22, 24, 26, 28), or may be applets/applications that may be executed within a client application. As such, risk control and analysis process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, risk control and analysis process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple IOS, ANDROID, or a custom operating system.

### The Risk Control and Analysis Process

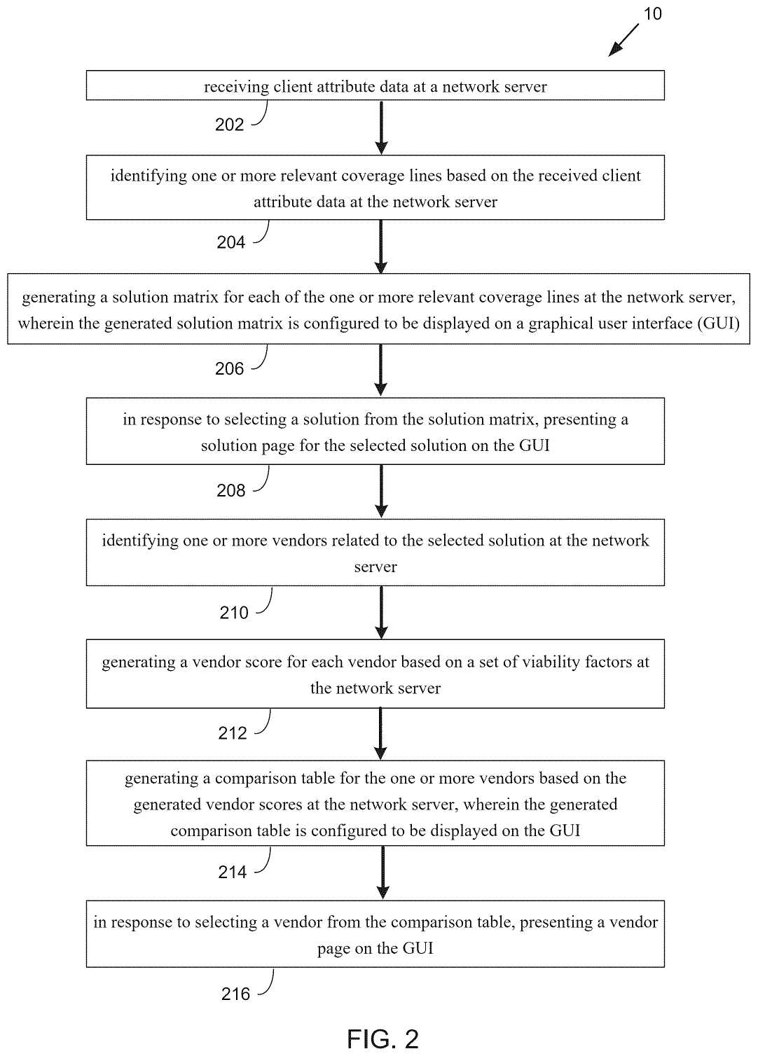

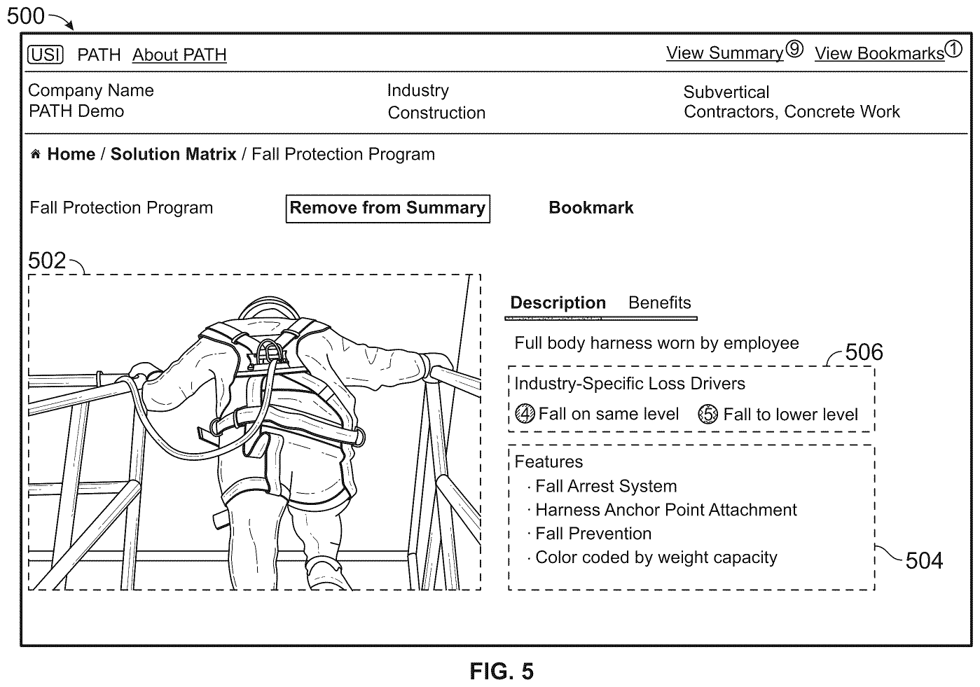

Referring also to FIGS. 2-9 and in some implementations, risk control and analysis process 10 may receive (202) client attribute data at a network server, identify (204) one or more relevant coverage lines based on the received client attribute data at the network server, and generate (206) a solution matrix for each of the one or more relevant coverage lines at the network server, where the generated solution matrix may be configured to be displayed on a graphical user interface (GUI). In response to selecting a solution from the solution matrix, risk control and analysis process 10 may further present (208) a solution page for the selected solution on the GUI, identify (210) one or more vendors related to the selected solution at the network server, and generate (212) a vendor score for each vendor based on a set of viability factors at the network server. Risk control and analysis process 10 may also generate (214) a comparison table for the one or more vendors based on the generated vendor scores at the network server, where the generated comparison table may be configured to be displayed on the GUI. In response to selecting a vendor from the comparison table, risk control and analysis process 10 may present (216) a vendor page on the GUI.

In some implementations, risk control and analysis process 10 may receive (202) client attribute data and identify (204) one or more relevant coverage lines based on the received client attribute data. Client attribute data may include factors like the products and services offered by the client (i.e. industry), the market share, the number of branch offices, the location of each office, the number of employees, etc. A coverage line may be a specific type or category of insurance coverage offered within an insurance policy or program. Coverage lines may be used to distinguish between different areas of risk or protection and may align with various aspects of a client's needs.

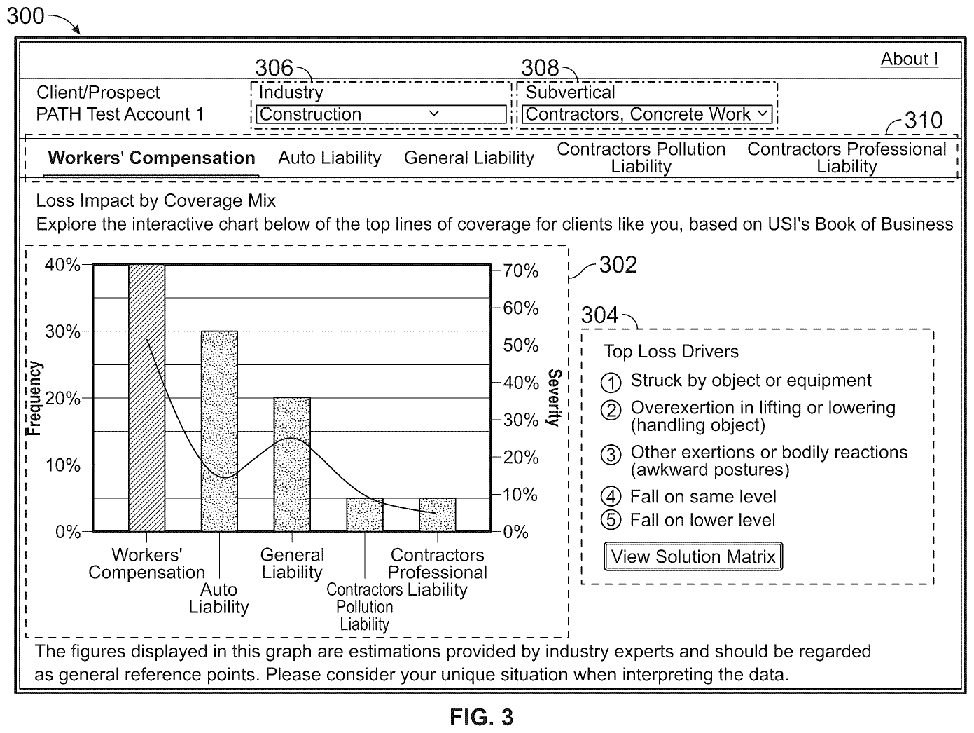

Consider for example, dashboard page 300 shown in FIG. 3. Dashboard page 300 may include a graphical depiction of one or more of the most relevant coverage lines, e.g. bar chart 302, and a corresponding list of loss drivers (e.g. listing 304). Loss drivers may refer to primary factors or underlying causes that contribute significantly to claims, financial losses, or risks within an organization. Identifying and understanding loss drivers may be critical for developing targeted strategies to mitigate risks and reduce the frequency or severity of claims. Data about the loss drivers may be sourced from aggregated claims data and industry experts. In some implementations, risk control and analysis process 10 may use a database of aggregated and anonymized client data to inform actual top lines of coverage and loss drivers within the data set. Loss drivers may still be augmented with additional industry data as needed. Futher, users may choose to customize their experience by uploading their loss runs (claims data) or by selecting their actual top loss drivers. Dashboard page 300 may also include one or more dropdown menus for additional filtering (e.g. industry 306 or subverticals 308). End-users may also use dashboard page 300 to explore the top causes of loss for other coverage lines by toggling through one or more tabs provided, for example ribbon 310 may include tabs for worker's compensation, auto liability, general liability, etc.

In some implementations, risk control and analysis process 10 may generate (206) a solution matrix for each of the one or more relevant coverage lines shown in bar chart 302. Each solution matrix may include a set of possible solutions and each solution from the set of possible solutions may be represented as a point in the solution matrix. Further, each point/solution in the solution matrix may be associated with one or more loss drivers. More generally, solutions may be identified by subject matter experts (SMEs) and through research of emerging technologies. Solutions may be associated with the loss drivers through review by SMEs, and solution matrix coordinates may be the result of input by SMEs. In some implementations, risk control and analysis process 10 may use a database of aggregated and anonymized client data that may include the captured results from solution/vendor results, which may further inform the solution matrix.

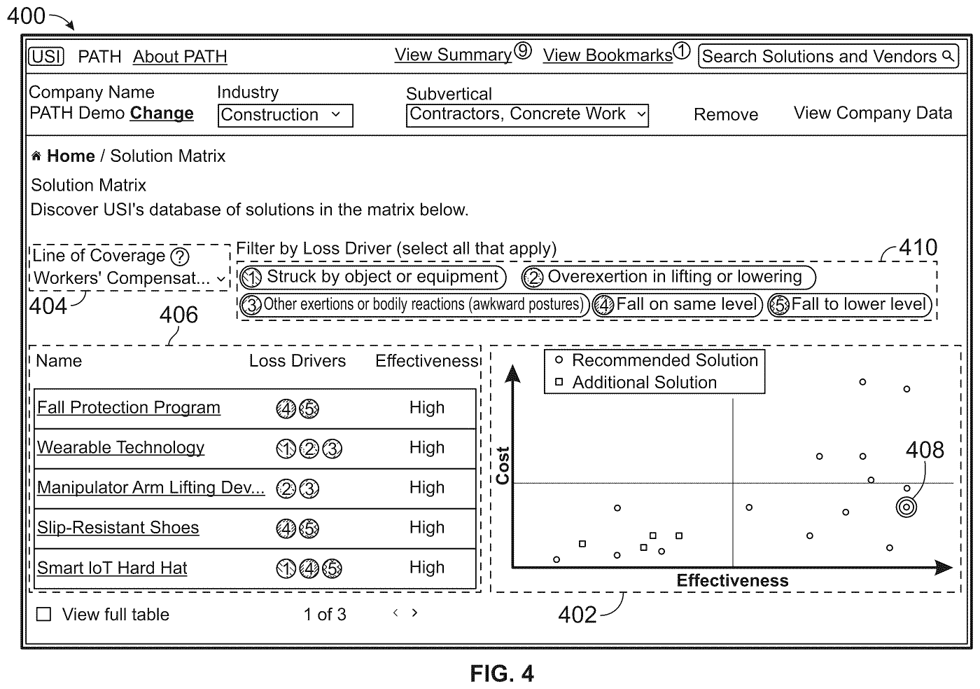

Consider, for example, dashboard page 400 shown in FIG. 4. The solution set for each coverage line may be plotted in a cost-effectiveness matrix, like solution matrix 402 plotted for the worker's compensation coverage line 404. End-users may examine solutions included in the set of possible solutions by hovering a cursor over solution matrix 402 or by examining solutions table 406, for example, the fall protection program solution 408 and a corresponding list of loss drivers. End-users may further filter what solutions are shown by selecting a loss driver from among the one or more loss drivers presented in loss driver ribbon 410. End-users may also toggle between different coverage lines by selecting from among the one or more coverage line tabs provided in coverage line dropdown menu.

In some implementations, in response to selecting a solution from the solution matrix, risk control and analysis process 10 may further present (208) a solution page, providing an overview of the potential solution. Consider, for example, solution page 500 for a wearable technology solution. Solution page 500 may include one or more images, videos, or other media (e.g. image 502) that may provide end-users with a better understanding of how the wearable technology solution works, what it may look like, or how it may be used. Solution page 500 may also include a brief synopsis of features (e.g. one or more features 504) or a brief synopsis of industry-specific loss drivers (e.g. one or more loss drivers 506). Further, solution page 500 may also provide a brief synopsis of possible benefits provided by the wearable technology solution.

In some implementations, risk control and analysis process 10 may further identify (210) one or more vendors related to the selected solution, generate (212) a vendor score for each vendor based on a set of viability factors, and generate (214) a comparison table for the one or more vendors based on the generated vendor scores. Vendors in this context may refer to any supplier of the products or services used in the selected solution. For example, in the previously discussed wearable technology solution, a vendor could be any provider of smart watches, smart glasses, etc. Vendor scores may represent a ranking system that end-users may use as a basis for comparison between vendors. Vendor scores may be based on a set of viability factors including, but not limited to: (i) relevance of vendor products to the selected solution, (ii) history of performance, (iii) overall price, and (iv) availability of discounts. Vendor scores may also be achieved via a weighted average of the identified feature set of a solution and a vendor's ability to provide each feature. In some implementations, risk control and analysis process 10 may use a database of aggregated and anonymized client data that may include the captured results from solution/vendor results, which may allow for additional scoring based on actual results generated for end-users.

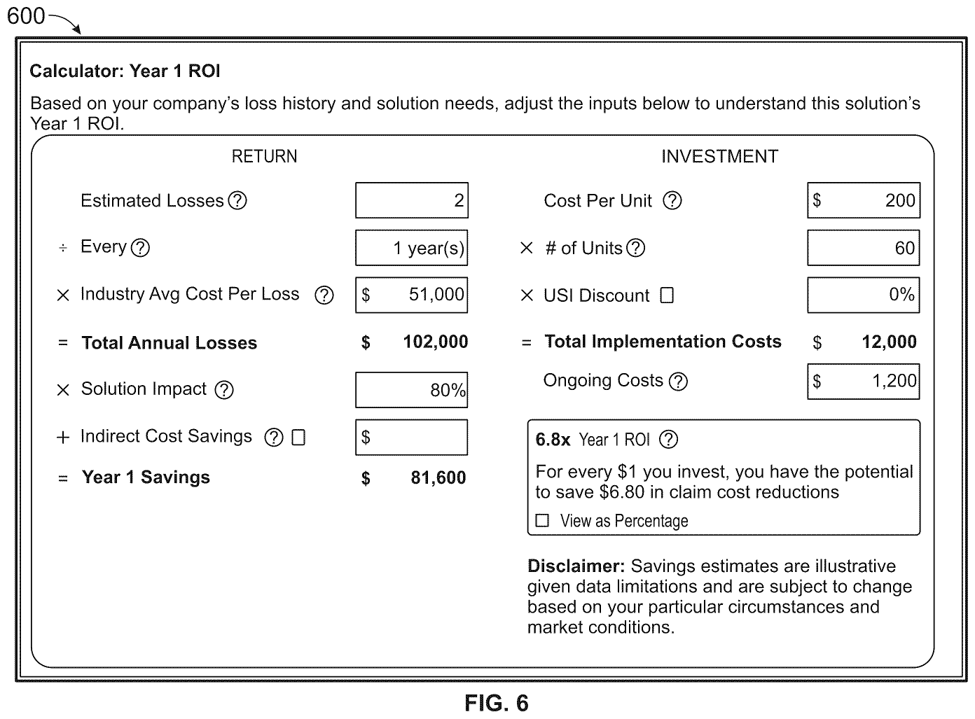

In some implementations, solution pages may include one or more of an interactive calculator for estimating first-year return on investment (ROI), an ROI projection tool, and a vendor comparison. Consider, for example, solution page 600, shown in FIG. 6. Solution page 600 may allow end-users to perform ROI analyses with an interactive calculator based on the client company's history of loss and apparent solution needs. On the returns side, the interactive calculator may consider factors like: (i) estimated losses, (ii) industry average cost per loss, (iii) solution impact, and (iv) indirect cost savings. On the investment side, the interactive calculator may consider factors like: (i) cost per unit, (ii) number of units, and (iii) percentage discount if any. The interactive calculator may compute a first year loss sensitive ROI based on implementation costs for that solution and claims data.

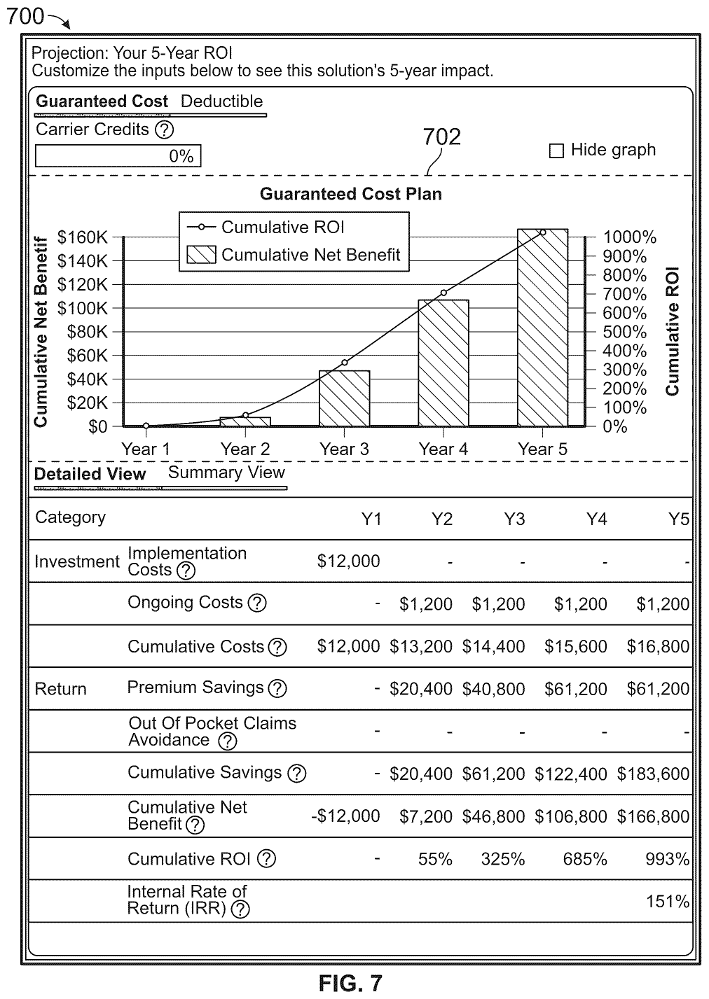

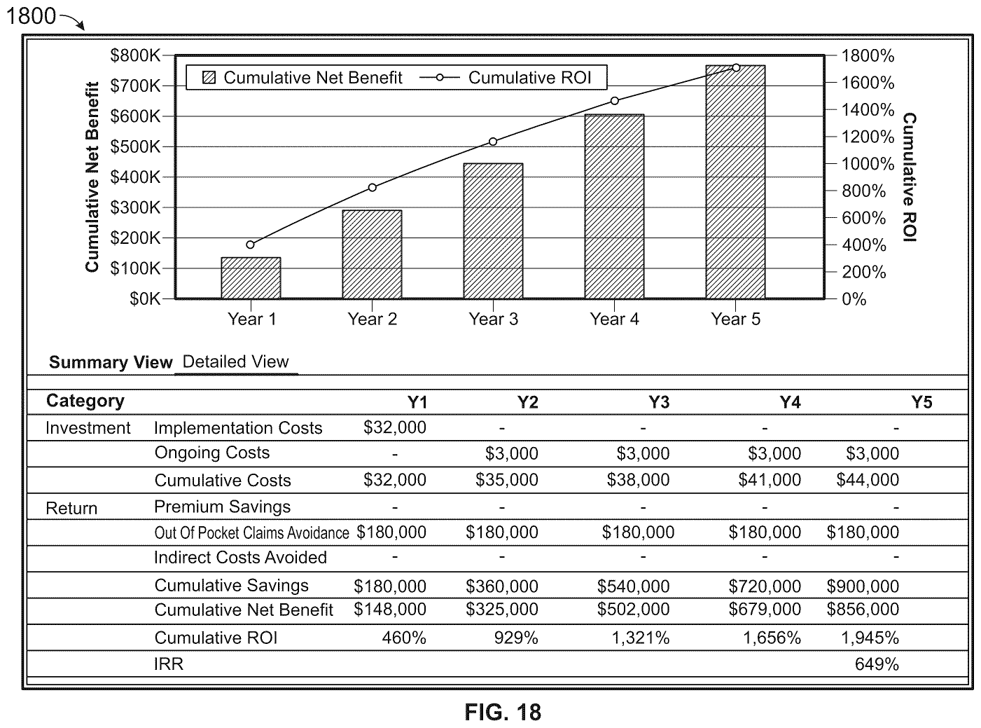

Consider for example solution page 700 shown in FIG. 7, which may provide end-users with a five-year projection tool (e.g. ROI projection 702) that considers the type of funding and carrier credits to graph the cumulative net benefit and ROI of implementing the solution. In some implementations, the 5-year ROI projection may model the dollar savings, and consider the funding type (guaranteed cost or deductible) and carrier credits. These models may be created with SMEs to show the potential impact of reduced losses on future premiums paid. The ROI model may be further refined using a database of aggregated/anonymized client data, actual vendor results for those clients, and a claims benchmarking tool. Such data may allow to have pre-negotiated credits with specific carriers. Risk control and analysis process 10 may use a database of aggregated and anonymized client data that may include the captured results from solution/vendor results, which may allow risk control and analysis process 10 to generate additional scoring based on actual results generated for end-users. End-users may also view a summary and detailed breakdown of the projection (see FIG. 18).

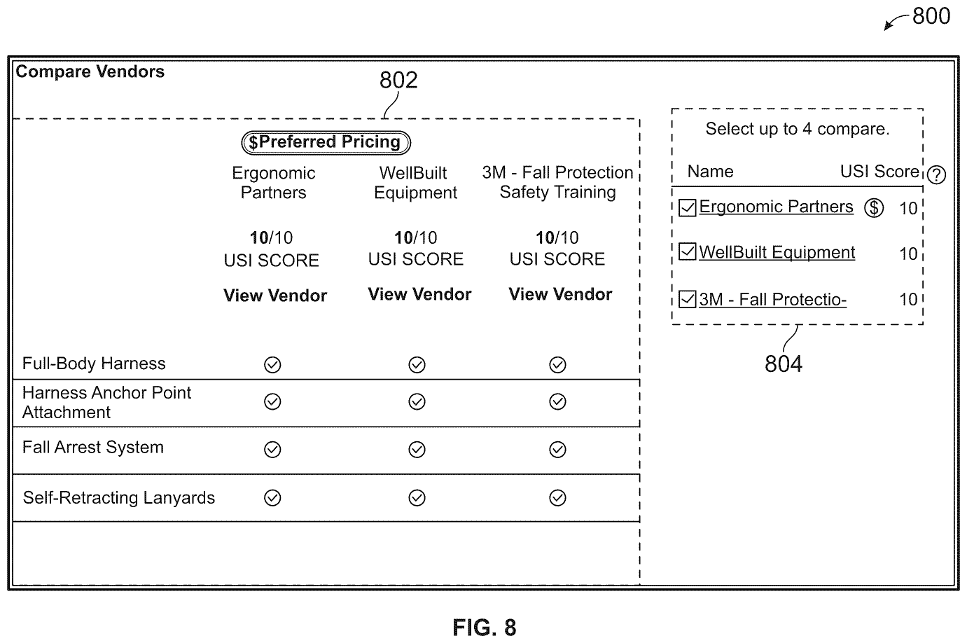

Consider for example solution page 800 shown in FIG. 8, which may provide end-users with a vendor comparison table (e.g. vendor table 802) that may show several vendors side-by-side, along with which features they provide and which features they do not provide. Vendor table 802 may also provide the generated vendor scores and indicate which vendors if any provide in-network discounted prices for added convenience. Where the amount discounted may vary based on the individual vendor involved. Solution page 800 may also allow end-users to select one or more vendors for comparison from a pool of available vendors (vendor list 804).

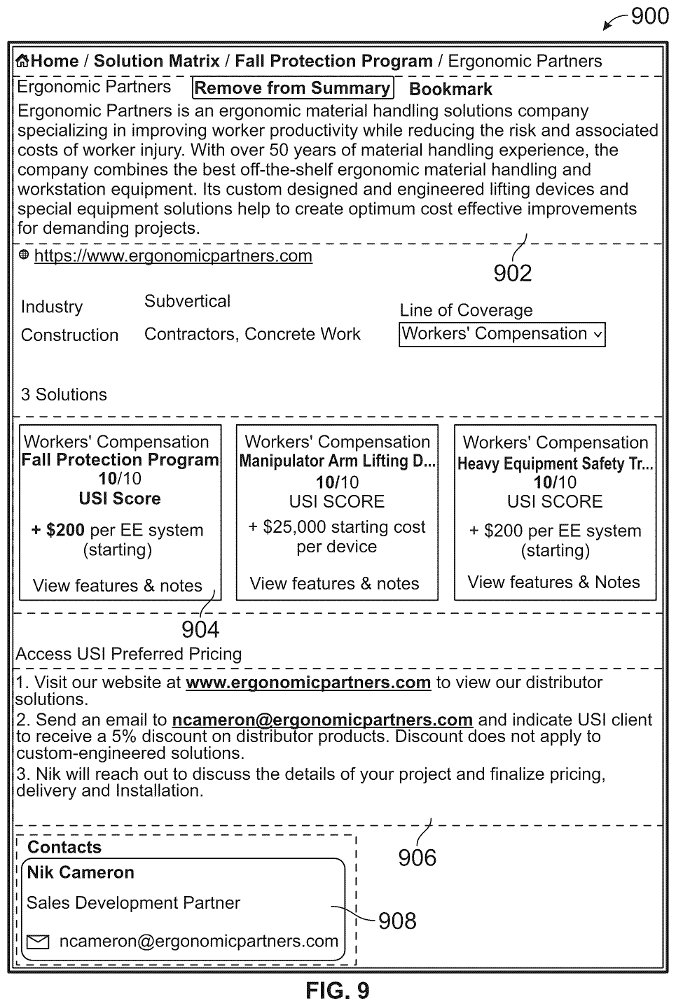

In response to selecting a vendor from the comparison table, in some implementations risk control and analysis process 10 may further present (216) a vendor page. End-users may view a vendor page by selecting a vendor from vendor table 802. Consider, for example, vendor page 900 shown in FIG. 9, which may provide an overview (e.g. overview 902) of the selected vendor and the products and/or services that they offer. The solutions offered by the vendor may be detailed in a carousel menu (e.g. solutions menu 904), where end-users may browse pricing and feature information. Vendors who elect to offer discounted pricing may also provide information (e.g. discount steps 906) on how to redeem the discount on vendor page 900. Similarly, if a vendor elects to display point-of-contact information for an agent, the agent's contact details (e.g. contact info 908) may also be provided on vendor page 900.

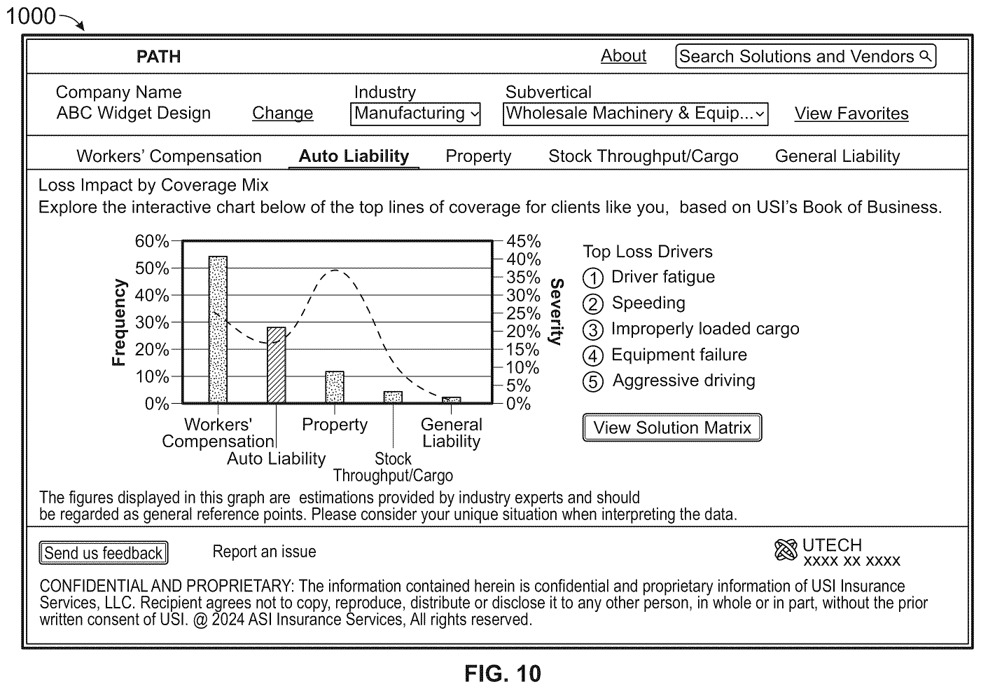

Referring now to FIG. 10, webpage 1000 is provided with details of a coverage line consistent with embodiments of the present disclosure. Webpage 1000 may provide a deeper understanding of an “Auto-Liability” coverage line for a company called “ABC Widget Design”. Moreover, webpage 1000 may provide a breakdown of loss impact by coverage mix, which gives a graph of loss impact information and a corresponding list of loss drivers for each coverage line. End-users may examine similar graphs and loss driver lists for each coverage line.

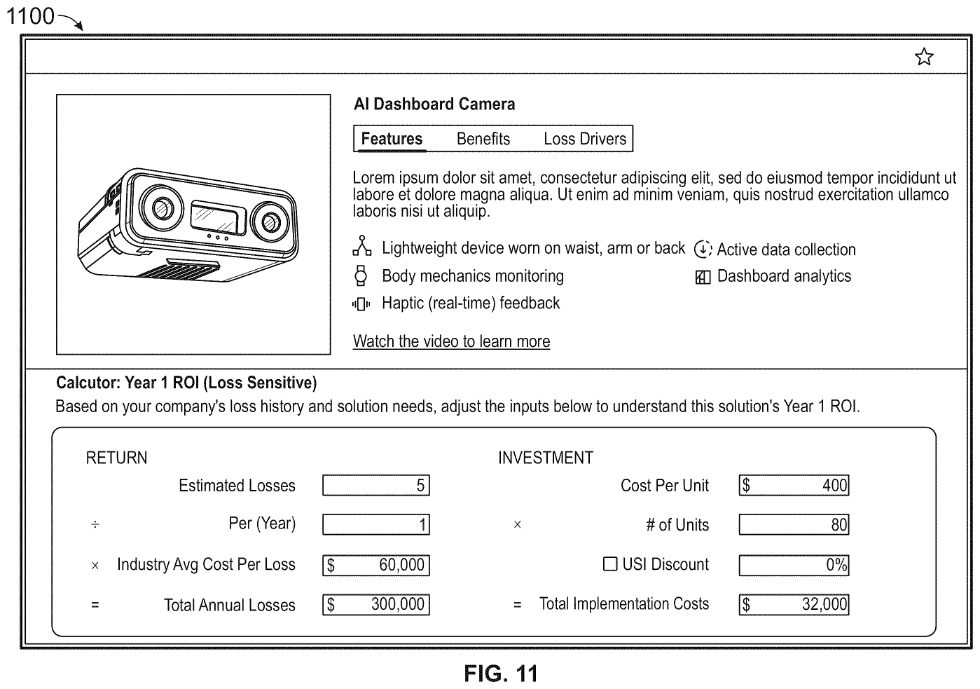

Referring now to FIG. 11, webpage 1100 is provided showing an overview of a solution page for an “AI Dashboard Camera”. The overview may provide detailed information about the features of the solution, and end-users may also view details on the associated benefits and loss drivers for the solution. Additionally, webpage 1100 may include a one year return on investment (ROI) calculator, pre-populated with data relevant to the solution being considered.

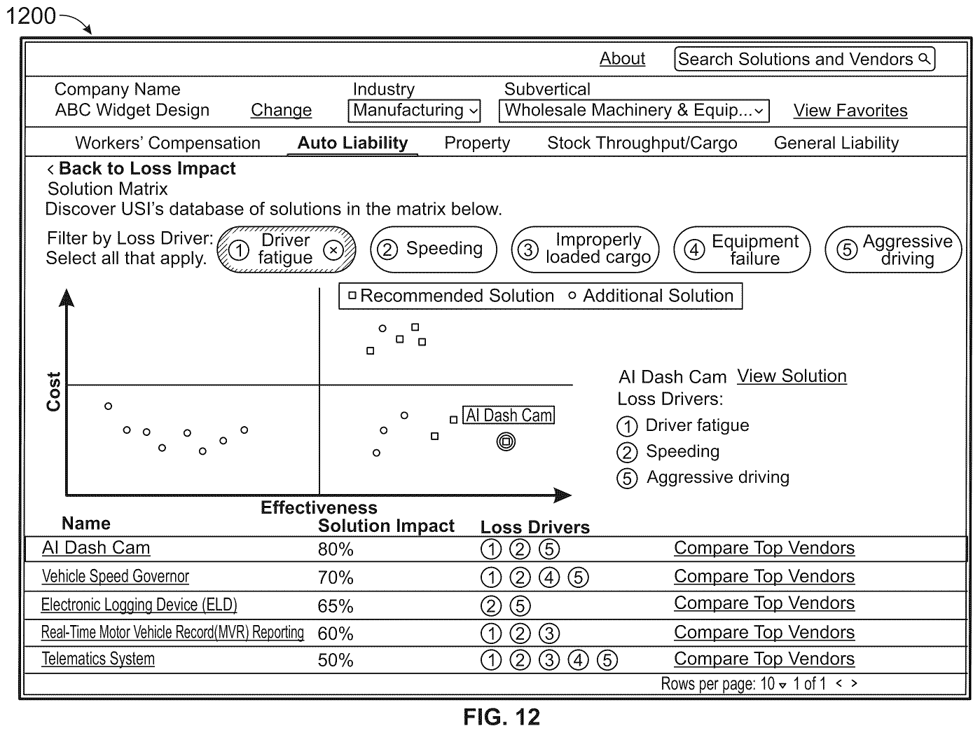

Referring now to FIG. 12, webpage 1200 is provided showing an overview of a solution page for an “AI Dashboard Camera”. Webpage 1200 may continue with the example of the “Auto-Liability” coverage line for “ABC Widget Design”. In particular, webpage 1200 may show a solution matrix, where the “AI Dashboard Camera” solution previously discussed in FIG. 11 is selected. The bottom of webpage 1200 may show a comparison of solutions for the auto-liability coverage line, of which the AI dashboard camera was ranked highest with an estimated 80% solution impact, which may be a measure of the effectiveness of the solution.

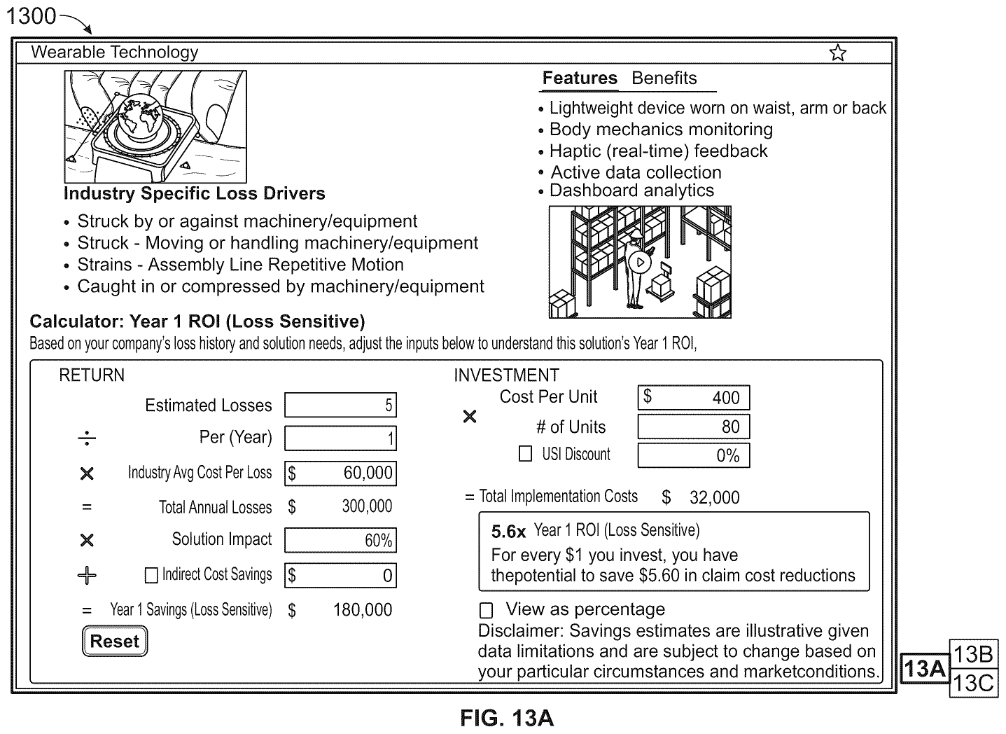

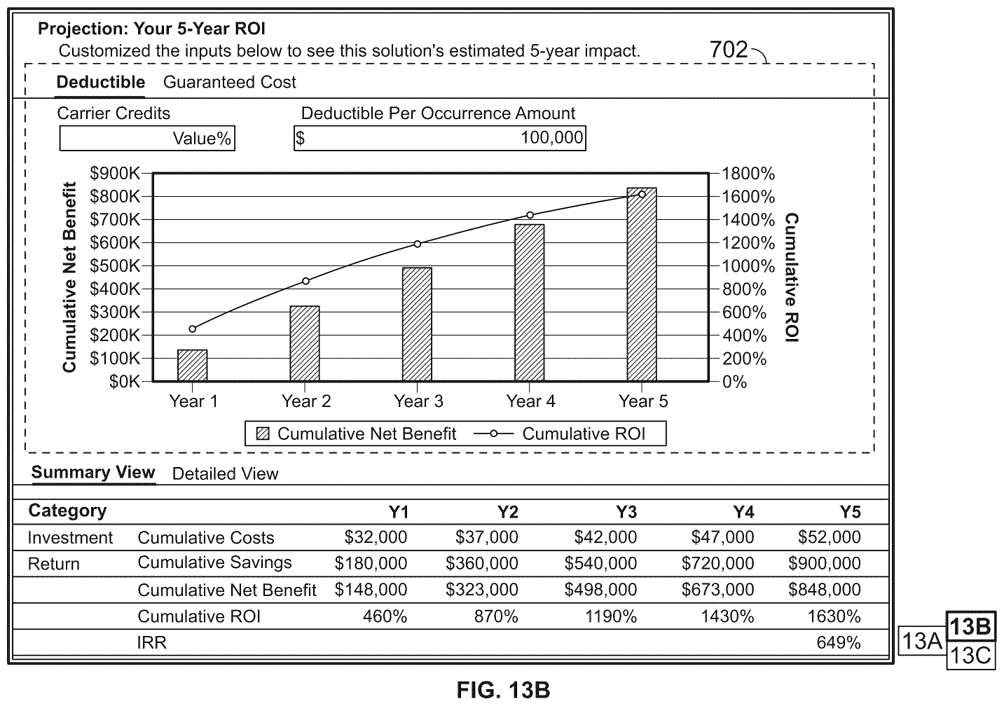

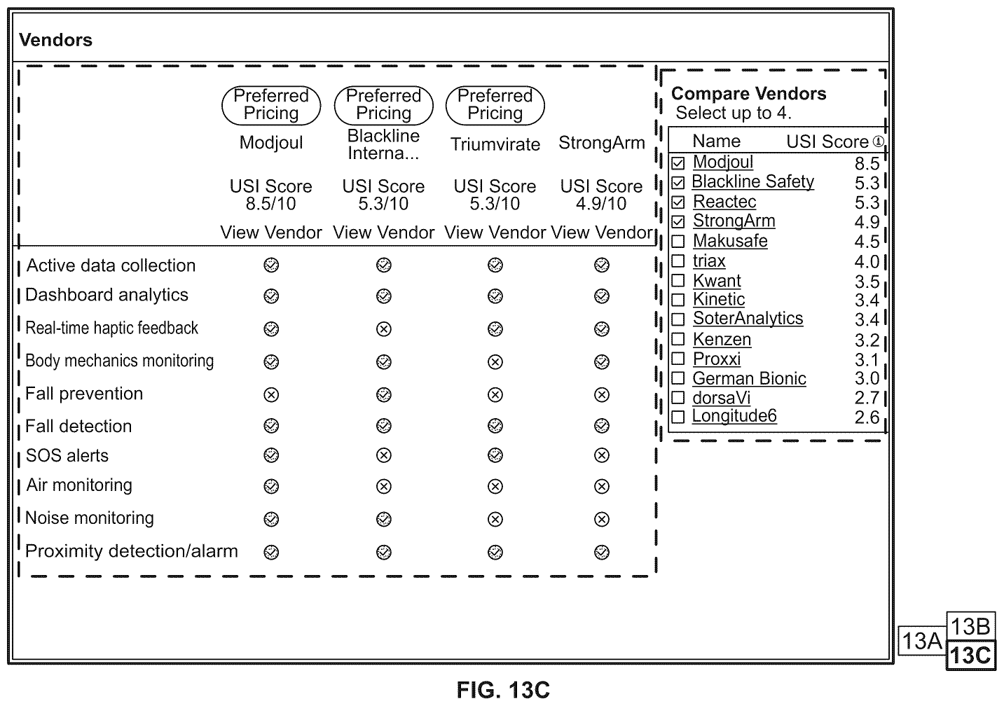

Referring now to FIGS. 13A-C, a single webpage 1300 is provided, but due to practical restrictions on image size and quality has been broken down and spread across three pages. Webpage 1300 may provide details for a “Wearable Technology” solution. For example, FIG. 13A may show a listing of industry-specific loss drivers and a one year ROI calculator, pre-populated with data relevant to the solution being considered. FIG. 13A may also show where end-users are able to view details on the features or benefits of the wearable technology solution. FIG. 13B may provide a 5-year ROI projection of how adopting the wearable technology solution might play out, and may also show where end-users may access either a summary view or a detailed view of the solution impact for each year over the 5 year projection. FIG. 13C may provide a comparison of vendors who may provide the solution being considered, in this case the wearable technology solution. The vendor comparison my place each vendor side by side and give end-users the opportunity to clearly see what features each of the solution each vendor is able to provide and which features if any they do not provide.

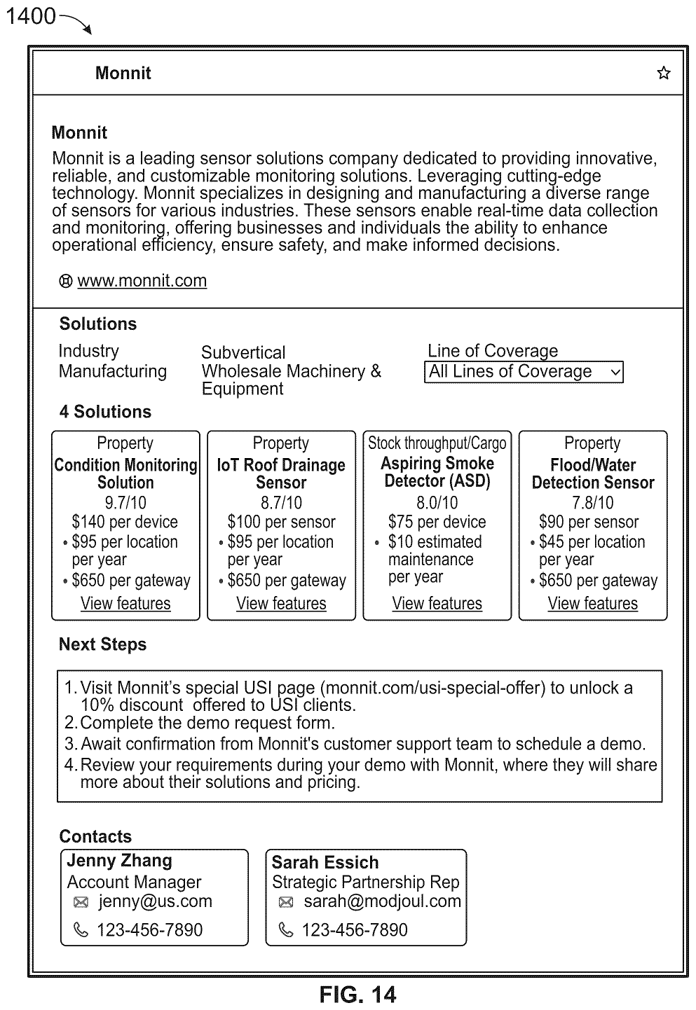

Referring now to FIG. 14, a webpage 1400 is provided showing an overview of a selected vendor and the products and/or services that they offer. In this case the vendor may be a company called “Monnit” and webpage 1400 may provide details for each solution offered by the vendor, such that end-users may browse pricing and feature information. Vendors who elect to offer discounted pricing may also provide information on how to redeem the discount. Vendors may also elect to display point-of-contact information for an agent, the agent's contact details may also be provided.

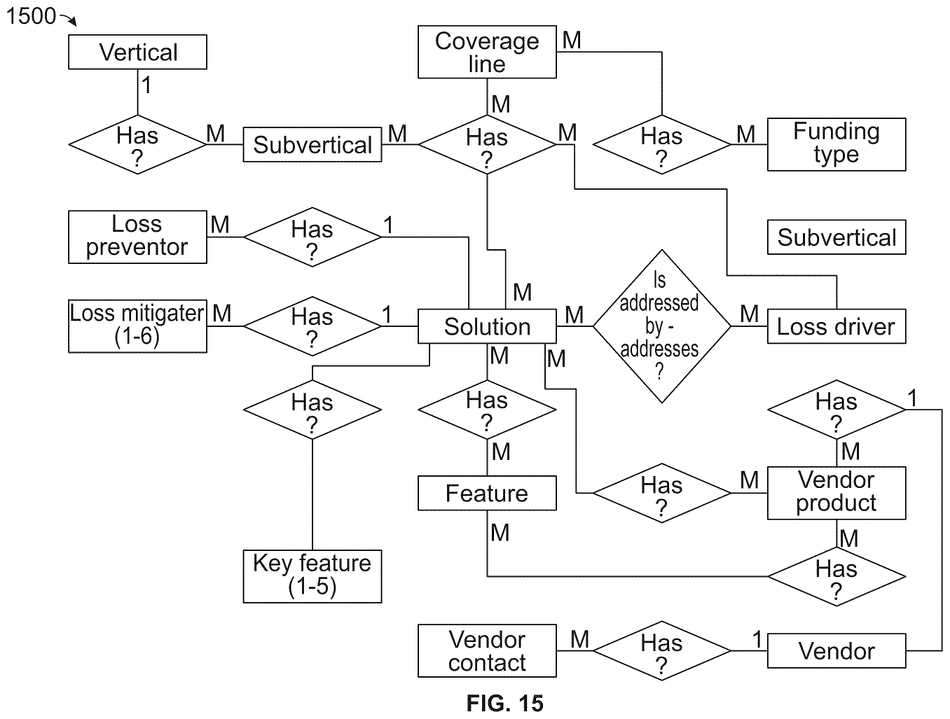

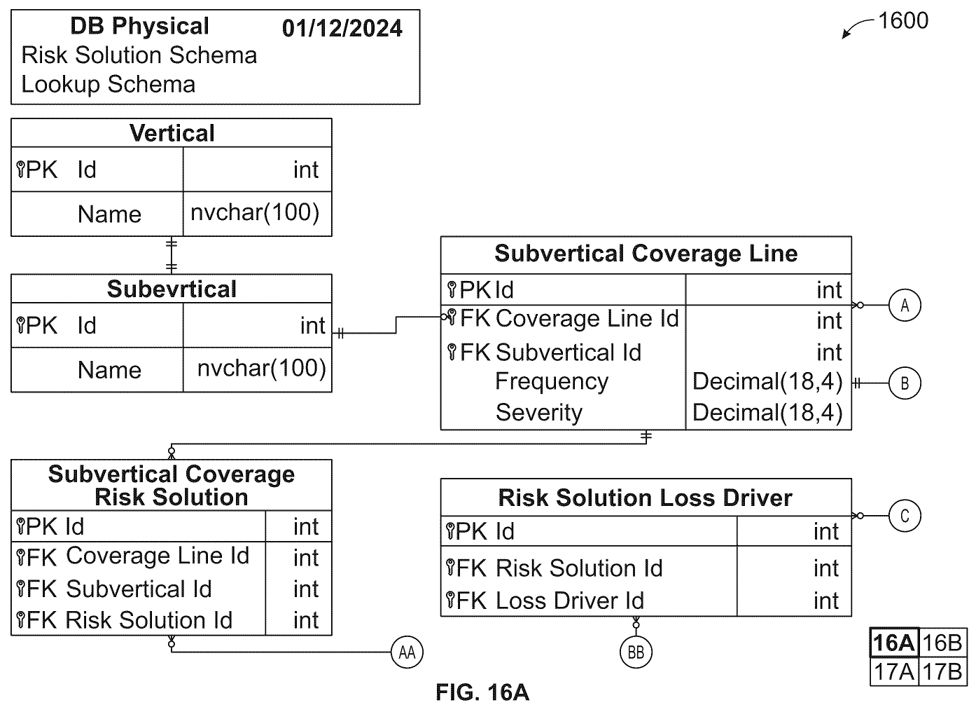

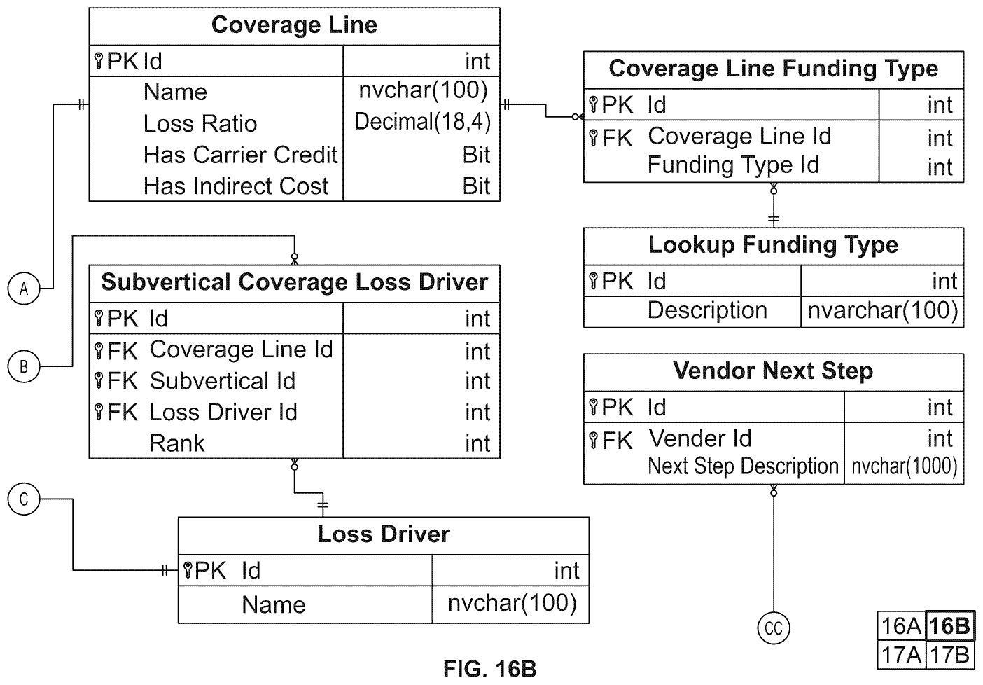

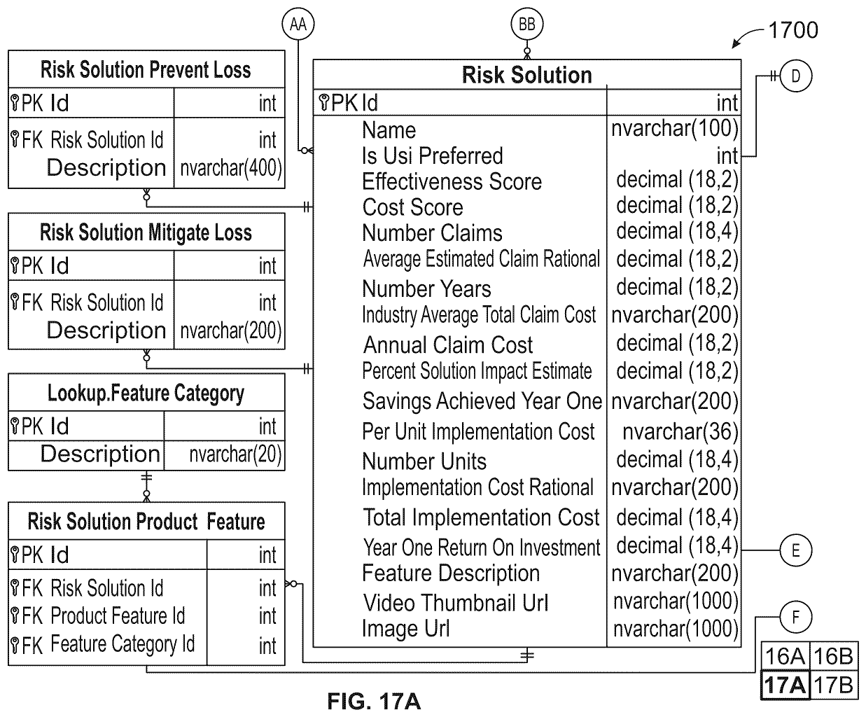

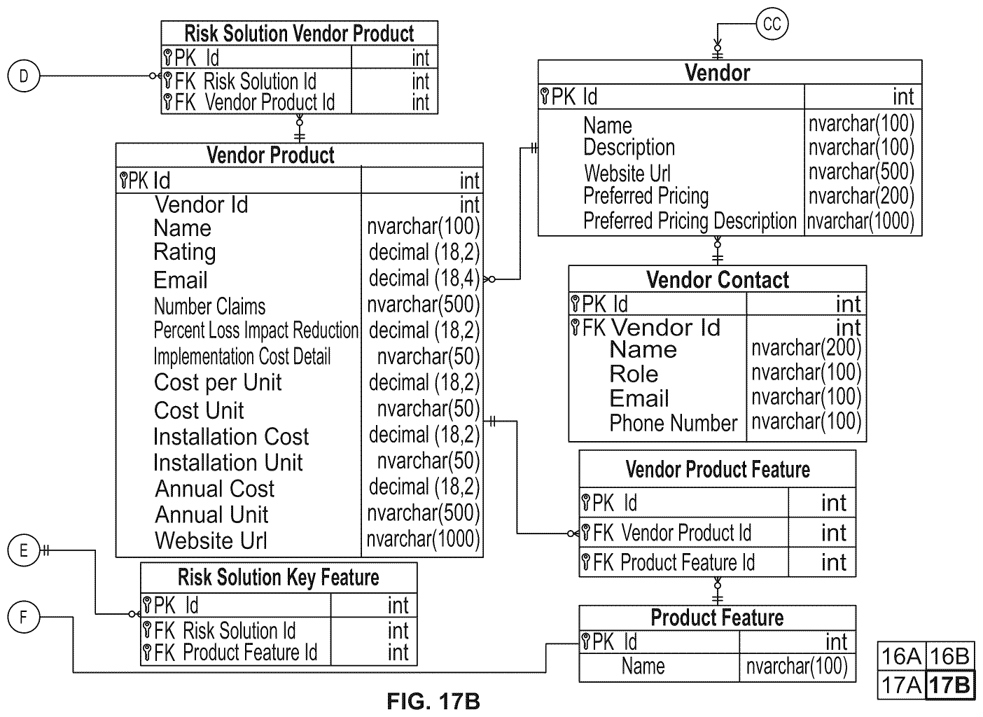

Referring now to FIGS. 15-17, a risk control and analysis process conceptual data model 1500, a risk control and analysis process schema 1600, and a risk control and analysis lookup schema 1700 are provided. Risk control and analysis process schema 1600 may be a structured framework that organizes and stores comprehensive data related to risk assessment. This schema may capture key metrics such as risk factors, policyholder data, historical claims, and risk exposure to provide actionable insights for underwriting and claims management. On the other hand, risk control and analysis lookup schema 1700 may serve as a reference system that stores predefined risk parameters, industry benchmarks, and standard risk categories, allowing for efficient cross-referencing and comparison with data in the process schema. These two schemas may be closely related, as the lookup schema provides static, reference data that enhances the dynamic, transactional data within the process schema, enabling more accurate and informed decision-making throughout the risk control and analysis process. Together, process schema 1600 and lookup schema 1700 ensure that risk analysis may be both comprehensive and adaptable to evolving data.

Referring now to FIG. 18, webpage 1800 is provided showing a 5-year ROI projection of how adopting another solution might play out, and may also show where end-users may access either a summary view or a detailed view of the solution impact for each year over the 5 year projection.

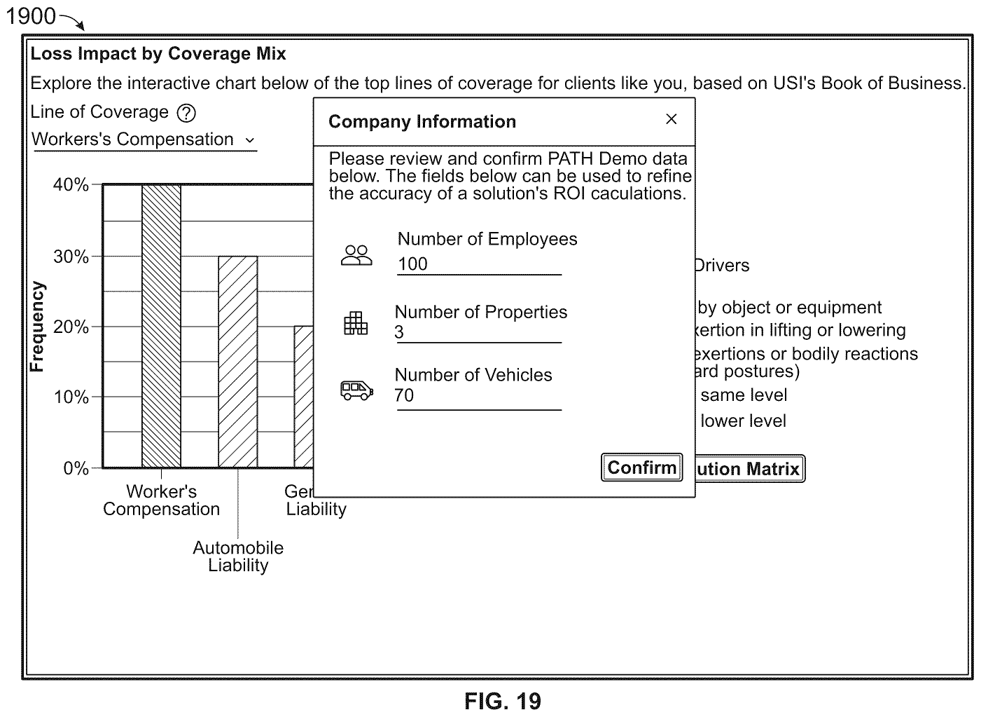

Referring now to FIG. 19, webpage 1900 is provided showing where an end-user may be prompted to confirm firmographic data. This information, paired with backend industry, solution, and vendor data, may be used to provide automatic solution ROI estimates with little to no intervention from the user.

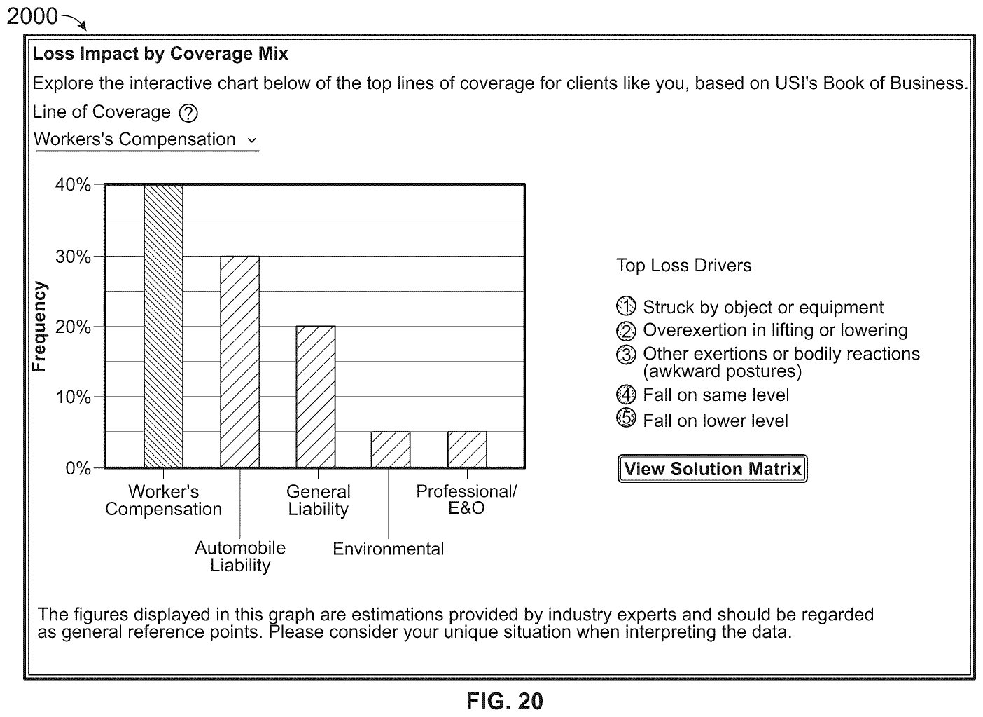

Referring now to FIG. 20, webpage 2000 is provided showing a breakdown of loss impact by coverage mix, which gives a graph of loss impact information and a corresponding list of loss drivers for each coverage line. End-users may examine similar graphs and loss driver lists for each coverage line. Webpage 2000 may present end-users with the top coverage lines and respective top causes of loss for their industry, such that the user may explore different industries and subverticals. The end-user may also explore the top causes of loss for other coverage lines in the dropdown menu.

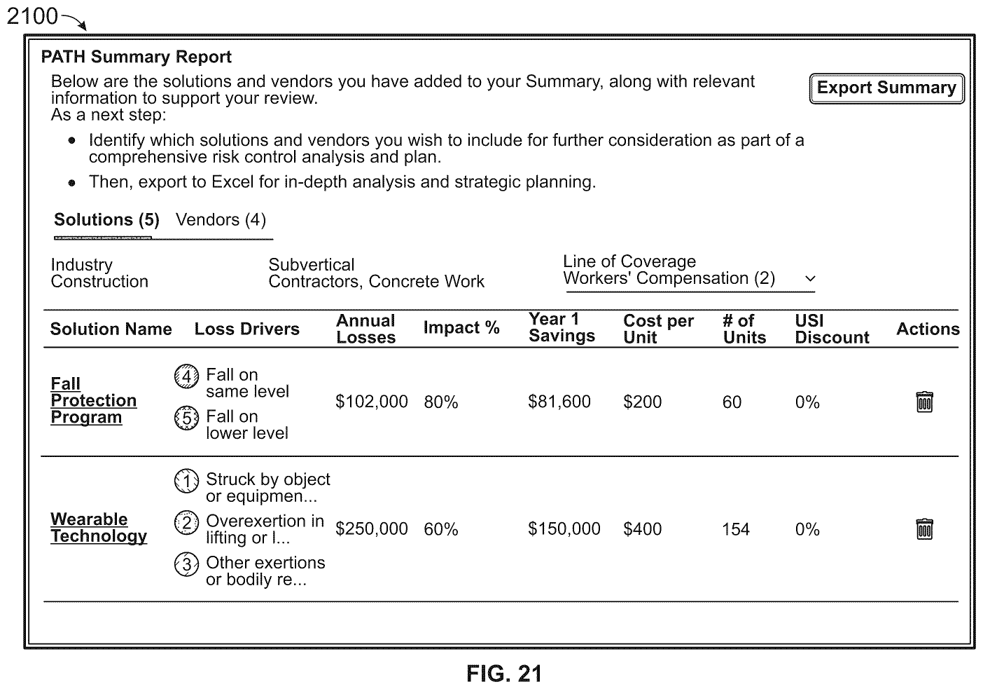

Referring now to FIG. 21, example 2100 is provided showing a summary report for one or more solutions selected by an end-user, where the end-user may add solutions with customized ROIs and vendors to a summary page. Furthermore, the summary report may be exported to Excel file for more in-depth analysis and strategic planning.

In some implementations, risk control and analysis process 10 may provide an automated extraction of data from various document formats, including unstructured or semi-structured documents like PDFs and structured documents such as Excel and Comma Separated Values (CSV) files. Risk control and analysis process 10 may guide these documents through a unified pipeline, while efficiently extracting business-defined data and storing it in an enterprise data warehouse. This robust solution may enhance data management and utilization, making it highly effective for diverse applications. Document Insights may take as input, a file listing insurance claims (client attribute data) and return the data in a structured format for analysis.

In some implementations, the data extraction process may include three major stages: pre-processing, parsing, and validation. The pre-processing stage may involve the initial cleaning and preparation of documents to enhance data readability. The parsing stage may involve utilizing specialized algorithms to interpret and extract relevant data fields from each document type. The validation stage may involve ensuring the accuracy and completeness of extracted data through cross-referencing and error-checking mechanisms.

In some implementations, risk control and analysis process 10 may assemble all extracted and integrated data into a single javascript object notation (JSON) output. This JSON file may serve as a comprehensive representation of the processed data, ready for further analysis or application. Once extracted, the data may be transformed into a structured format and integrated into an enterprise data warehouse. More specifically, the data may efficiently upload the transformed data into a cloud-based data warehouse platform, ensuring minimal latency and data integrity, then the extracted data may be converted into a standardized format suitable for use in downstream applications. Risk control and analysis process 10 may be designed to be easily implemented and scaled, allowing for adaptation to various document types.

In some implementations, risk control and analysis process 10 may provide numerous advantages over existing approaches. Some of these may include but are not limited to, the concepts identified below. Aggregation of industry benchmarks, client loss data, and intellectual capital that provides the client with a self-service risk control platform. A curated list of solutions and relevant vendors tailored to the client's industry and loss drivers supported with ROI projections and preferred vendor pricing. 5-Year premium projections provide leverage proprietary assumptions for different program structures. Negotiated premium credits with select carriers. Comparison grid of top vendors and prioritized features for each solution.

In some implementations, by integrating industry benchmarks, clients may compare their risk profile against industry standards, identifying strengths and weaknesses in their risk management practices. Clients may also gain data-driven insights on how their risk exposure may compare to their peers, helping them make more informed decisions. Client loss data may enable users to identify trends and patterns in their own claims history, thereby helping them to proactively address recurring risks. With predictive analytics, risk control and analysis process 10 may offer customized recommendations to reduce future losses.

In some implementations, by leveraging intellectual capital (e.g., expert insights, proprietary risk models, best practices), risk control and analysis process 10 may provide automated guidance tailored to the client's specific industry and risk factors. Clients may access expert-level risk control recommendations without needing an in-person consultant, saving time and money. Moreover, a self-service model may allow clients to independently access risk analysis tools, reducing reliance on manual intervention.

In some implementations, real-time analytics and dashboards may provide instant feedback on risk exposure, empowering clients to make timely adjustments. Risk control and analysis process 10 may also be adapted to different industries, risk tolerances, and business sizes, making it scalable for a variety of clients. Further, clients may set parameters and tailor reports based on their unique risk environment. By minimizing manual risk assessments and consultant dependencies, clients may be able reduce operational costs. The automation of risk control and analysis process 10 may ensure consistent, accurate, and repeatable assessments. Additionally risk control and analysis process 10 may help clients stay compliant with industry regulations by maintaining up-to-date risk management practices. Centralized data storage may ensure easy access to risk documentation and audit trails for regulatory reporting.

In some embodiments, risk control and analysis process 10 may provide the ability to ingest loss run data from carriers for an even more personalized experience. The process may provide a vendor portal or access point for third-parties to make edits to their pages and product info directly. The process may export a “Risk Control Plan” report. The process may also provide Search, favoriting, and other helpful features to enhance user experience. The process may additionally provide analytics that measure the impact of risk control solutions on client's actual loss costs and premiums over time.

It will be apparent to those skilled in the art that various modifications and variations can be made to PATH process 10 and/or embodiments of the present disclosure without departing from the spirit or scope of the invention. Thus, it is intended that embodiments of the present disclosure cover the modifications and variations of this invention provided they come within the scope of the appended claims and their equivalents.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method executed on a computing device for risk control analysis, comprising:
receiving client attribute data at a network server;
identifying one or more relevant coverage lines based on the received client attribute data at the network server; and
generating a solution matrix for each of the one or more relevant coverage lines at the network server, wherein the generated solution matrix is configured to be displayed on a graphical user interface (GUI).

2. The computer-implemented method of claim 1, wherein each solution matrix includes a set of possible solutions and each solution from the set of possible solutions is represented as a point in the solution matrix.

3. The computer-implemented method of claim 2, wherein each point in the solution matrix includes one or more loss drivers.

4. The computer-implemented method of claim 2, further including:
in response to selecting a solution from the solution matrix, presenting a solution page for the selected solution on the GUI.

5. The computer-implemented method of claim 4, wherein the solution page includes more detailed information about the selected solution and one or more of a projection tool, a return on investment (ROI) analysis, an interactive calculator, and a vendor comparison.

6. The computer-implemented method of claim 4, further including:
identifying one or more vendors related to the selected solution at the network server;
generating a vendor score for each vendor based on a set of viability factors at the network server; and
generating a comparison table for the one or more vendors based on the generated vendor scores at the network server, wherein the generated comparison table is configured to be displayed on the GUI.

7. The computer-implemented method of claim 6, wherein the set of viability factors include at least one of relevance of vendor products to the selected solution, history of performance, overall price, availability of discounts.

8. The computer-implemented method of claim 6, further including:
in response to selecting a vendor from the comparison table, presenting a vendor page on the GUI.

9. The computer-implemented method of claim 8, wherein the vendor page includes one or more of an overview of vendor products and services, available discounts, and contact information.

10. A computing system comprising:
a memory; and
a processor configured to receive client attribute data at a network server, to identify one or more relevant coverage lines based on the received client attribute data at the network server, and to generate a solution matrix for each of the one or more relevant coverage lines at the network server, wherein the generated solution matrix is configured to be displayed on a graphical user interface (GUI).

11. The computing system of claim 10, wherein each solution matrix includes a set of possible solutions, and each solution from the set of possible solutions is represented as a point in the solution matrix.

12. The computing system of claim 11, wherein each point in the solution matrix includes one or more loss drivers.

13. The computing system of claim 11, further including:
in response to selecting a solution from the solution matrix, presenting a solution page for the selected solution on the GUI.

14. The computing system of claim 13, wherein the solution page includes more detailed information about the selected solution and one or more of a projection tool, a return on investment (ROI) analysis, an interactive calculator, and a vendor comparison.

15. The computing system of claim 13, wherein the processor is further configured to:
identify one or more vendors related to the selected solution at the network server;
generate a vendor score for each vendor based on a set of viability factors at the network server; and
generate a comparison table for the one or more vendors based on the generated vendor scores at the network server, wherein the generated comparison table is configured to be displayed on the GUI.

16. The computing system of claim 15, wherein the set of viability factors include at least one of relevance of vendor products to the selected solution, history of performance, overall price, availability of discounts.

17. The computing system of claim 15, further including:
in response to selecting a vendor from the comparison table, presenting a vendor page to be displayed on the GUI.

18. The computing system of claim 17, wherein the vendor page includes one or more of an overview of vendor products and services, available discounts, and contact information.

19. A computer program product residing on a non-transitory computer readable medium having a plurality of instructions stored thereon which, when executed by a processor, cause the processor to perform operations comprising:
receiving client attribute data at a network server;
identifying one or more relevant coverage lines based on the received client attribute data at the network server; and
generating a solution matrix for each of the one or more relevant coverage lines at the network server, wherein the generated solution matrix is configured to be displayed on a graphical user interface (GUI).

20. The computer program product of claim 19, wherein each solution matrix includes a set of possible solutions, and each solution from the set of possible solutions is represented as a point in the solution matrix.
